(19) United States
(12) Patent Application Publication
(10) Pub. No.: US 2026/0018652 A1
(43) Pub. Date: Jan. 15, 2026

(54) ELECTRODE ASSEMBLY AND BATTERY CELL INCLUDING THE SAME

(71) Applicant: SK On Co., Ltd., Seoul (KR)

(72) Inventors: Won Seok JEONG, Daejeon (KR); Hae Ryong JEON, Daejeon (KR)

(21) Appl. No.: 19/264,757

(22) Filed: Jul. 9, 2025

(30) Foreign Application Priority Data
Jul. 10, 2024 (KR) 10-2024-0090974

(51) Int. Cl. H01M 10/04; H01M 50/107

(52) U.S. Cl. CPC H01M 10/0431; H01M 50/107

(57) ABSTRACT

An electrode assembly according to the present disclosure includes a first electrode and a second electrode, wherein the first electrode and the second electrode are wound into a roll, wherein the first electrode comprises a first coated region in which a first active material is coated on a first current collector, and a first uncoated region adjacent to the first coated region, wherein the second electrode comprises a second coated region in which a second active material is coated on a second current collector, and a second uncoated region adjacent to the second coated region, and wherein a height of at least one of the first current collector.

### CROSS-REFERENCE TO RELATED PATENT APPLICATION

The present application claims priority under 35 U.S.C. § 119(a) to Korean patent application number 10-2024-0090974 filed on July 10, 2024 in the Korean Intellectual Property Office, the entire disclosed portion of which is incorporated by reference herein.

### BACKGROUND OF THE INVENTION

### Field

The present disclosure relates to an electrode assembly and a battery cell including the same.

### Description of the Related Art

Secondary batteries convert electrical energy into chemical energy and store the chemical energy so that the secondary batteries can be reused multiple times through charging and discharging. Secondary batteries are widely used throughout the industry due to their economical and eco-friendly characteristics. In particular, lithium secondary batteries are widely used in the entire industry, including portable devices which require high-density energy.

The operating principle of lithium secondary batteries is the electrochemical oxidation-reduction reaction. In other words, electricity is generated by the movement of lithium ions and is charged in the opposite process. In the case of a lithium secondary battery, a phenomenon in which lithium ions from an anode escape and move to a cathode through an electrolyte and a separator is called discharge. In addition, the opposite process of the phenomenon is called charge.

A large amount of heat may be generated during the charging and discharging processes. If this heat is not properly dissipated, the performance and reliability of secondary batteries may deteriorate. Therefore, extensive research is being conducted to improve heat dissipation and maintain the performance of secondary batteries.

### SUMMARY OF THE INVENTION

An aspect of the present disclosure is to provide an electrode assembly and a battery cell with improved stability and performance.

Another aspect of the present disclosure is to provide an electrode assembly and a battery cell with improved cooling efficiency.

In addition, the present disclosure may be widely applied in the fields of electric vehicles, battery charging stations, and other green technologies such as photovoltaics and wind power using batteries.

In addition, the present disclosure may be used in eco-friendly mobility, including electric vehicles, and hybrid vehicles, to prevent climate change by suppressing air pollution and greenhouse fluid emissions.

An electrode assembly according to embodiments of the present disclosure may include a first electrode and a second electrode, wherein the first electrode and the second electrode are wound into a roll, wherein the first electrode comprises a first coated region in which a first active material is coated on a first current collector, and a first uncoated region adjacent to the first coated region, wherein the second electrode comprises a second coated region in which a second active material is coated on a second current collector, and a second uncoated region adjacent to the second coated region, and wherein a height of at least one of the first current collector and the second current collector varies in a radial direction from a winding center.

The height of each of the first current collector and the second current collector may decrease in the radial direction from the winding center.

The height of each of the first current collector and the second current collector may increase in the radial direction from the winding center.

The first active material may be coated from one end of the first current collector toward the winding center to an other end of the first current collector.

The first uncoated region may include one edge of the first current collector from the one end of the first current collector toward the winding center to the other end of the first current collector.

A width of the first uncoated region may be the same in a height direction of the first current collector.

The first uncoated region may include a plurality of flags arranged at predetermined intervals.

The first current collector may have a trapezoidal shape.

The second electrode may be disposed on at least one surface of the first electrode.

A shape of the second current collector may correspond to a shape of the first current collector.

The second uncoated region may be provided on an opposite side of the first uncoated region in the axial direction of the winding center.

The second uncoated region may include a plurality of flags arranged at predetermined intervals.

The second current collector may have a trapezoidal shape.

A battery cell according to embodiments of the present disclosure may include the electrode assembly; and a housing receiving the electrode assembly.

The housing may include: an opening opened at one end; and a closed portion provided on an opposite side of the opening, and opposing surfaces of the electrode assembly and the closed portion may correspond to each other.

The closed portion may have a protruding region corresponding to the winding center.

The closed portion may have a recessed region corresponding to the winding center.

### BRIEF DESCRIPTION OF THE DRAWINGS

FIG. 1 illustrates a battery cell according to an embodiment of the present disclosure.

FIG. 2 illustrates a first electrode according to an embodiment of the present disclosure.

FIG. 3 is an enlarged view of an area A in FIG. 2.

FIG. 4 illustrates a second electrode according to an embodiment of the present disclosure.

FIG. 5 schematically illustrates a path for heat to be dissipated from an electrode assembly according to an embodiment of the present disclosure.

FIG. 6 illustrates an electrode assembly according to an embodiment of the present disclosure.

FIG. 7 illustrates how an electrode assembly is inserted into a housing.

FIG. 8 is a cross-sectional view of a battery cell according to an embodiment of the present disclosure.

FIG. 9 is a cross-sectional view of a battery cell according to another embodiment of the present disclosure.

FIG. 10 illustrates a battery cell according to another embodiment of the present disclosure.

FIG. 11 illustrates a first electrode according to another embodiment of the present disclosure.

FIG. 12 illustrates a second electrode according to another embodiment of the present disclosure.

FIG. 13 illustrates an electrode assembly according to another embodiment of the present disclosure.

FIG. 14 is a cross-sectional view of a battery cell according to another embodiment of the present disclosure.

FIG. 15 is a cross-sectional view of a battery cell according to another embodiment of the present disclosure.

### DETAILED DESCRIPTION

Hereinafter, the present disclosure will be described in detail with reference to the accompanying drawings. This is, however, illustrative only and not intended to limit the disclosed portion to the specific embodiments illustratively described.

The specific terms used herein are for convenience of description only and are not intended to be limiting exemplary embodiments.

For example, expressions such as "same" and "being same" indicate not only a state in which they are strictly the same, but also a state in which there is a tolerance or a difference in the degree to which the same function is obtained.

For example, expressions indicating relative or absolute arrangement such as "in a direction," "along a direction," "in parallel," "vertically," "centrally," "concentrically," or "coaxially" not only strictly indicate such arrangements, but also indicate a state of relative displacement with tolerances or an angle or distance to the extent that the same function is obtained.

To explain the present disclosure, descriptions below may be based on a spatial orthogonal coordinate system with X, Y, and Z axes orthogonal to each other. Each axis direction (X-axis direction, Y-axis direction, Z-axis direction) refers to both directions in which each axis extends.

The X-direction, Y-direction, and Z-direction mentioned below are for the purpose of explanation, so that the present disclosure may be clearly understood. The directions may be defined differently depending on where the reference is placed.

The use of terms such as 'first, second, and third' in front of the components mentioned below is only to avoid confusion about the components to which they are referred and is irrelevant to the order, importance, or master-slave relationship between the components, etc. For example, an embodiment that includes only a second component without a first component may also be implemented.

It is also to be understood that the terminology used herein is used for the purpose of describing particular embodiments only, and is not intended to limit the scope of the present invention. It must be noted that as used herein and in the appended claims, the singular forms "a," "an," and "the" include the plural reference unless the context clearly dictates otherwise.

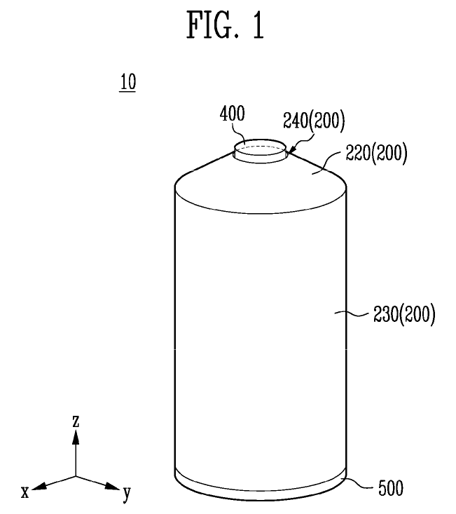

FIG. 1 illustrates a battery cell 10 according to an embodiment of the present disclosure.

An electrode assembly includes a first electrode and a second electrode. A first electrode 110 and a second electrode 120 are wound into a roll. The first electrode 110 includes a first coated region 1131 where a first active material 115 is coated on a first current collector 113, and a first uncoated region 1133 formed adjacent to the first coated region 1131. The second electrode 120 includes a second coated region 1231 where a second active material 125 is coated on a second current collector 123 and a second uncoated region 1233 formed adjacent to the second coated region 1231. A height of at least one of the first current collector 113 and the second current collector 123 varies in a radial direction from a winding center C.

In one embodiment, the battery cell 10 may comprise an electrode assembly 100 and a housing 200 receiving the electrode assembly 100. For example, the battery cell 10 includes an electrode assembly 100 and a housing 200 which accommodates the electrode assembly 100.

The battery cell 10 described herein refers to a secondary battery which may be used repeatedly by charging and discharging electrical energy. For example, the battery cell 10 may be a lithium secondary battery or a lithium-ion battery, but the present disclosure is not limited thereto. In another example, the battery cell 10 refers to an all- solid-state battery.

The battery cell 10 may be classified into a pouch secondary battery, a prismatic secondary battery, or a cylindrical secondary battery based on the shape thereof. Referring to FIG. 1, the battery cell 10 according to an embodiment of the present disclosure may be a cylindrical secondary battery with one projecting surface.

The housing 200 may house the electrode assembly 100. The housing 200 may form a receiving space therein. The receiving space may receive the electrode assembly 100. In an embodiment, the housing 200 may include various metals such as iron, aluminum, alloys thereof, plastics, ceramics, or carbon.

The housing may include: an opening with an opened end; and a closed portion formed on an opposite side of the opening. Surfaces where the electrode assembly and the closed portion oppose each other may correspond to each other.

In one embodiment, the housing 200 may comprise an opening 210 opened at one end, and a closed portion 220 provided on an opposite side of the opening 210, and opposing surfaces of the electrode assembly 100 and the closed portion 220 correspond to each other.

The housing 200 may include an opening 210. The opening 210 may be formed at one end of the housing 200. The opening 210 may allow the receiving space and the exterior of the housing 200 to communicate with each other. That is, the electrode assembly 100 may be inserted into the receiving space through the opening 210.

The housing 200 may further include a closed portion 220. The closed portion 220 may be formed at the other end of the housing 200. The opening 210 and the closed portion 220 may be formed on different surfaces of the housing 200. The opening 210 and the closed portion 220 may be formed on opposite surfaces in a height direction (e.g., in a Z-axis direction) of the housing 200.

The housing 200 may further include a side portion 230. The side portion 230 may connect the closed portion 220 and the opening 210. In other words, the closed portion 220 and the opening 210 may extend from an upper or lower end of the side portion 230. The upper or lower end may be one of the end portions in the height direction.

Referring to FIG. 1, the side portion 230 may extend in the height direction of the housing 200. The closed portion 220 may be formed at the upper end of the side portion 230, and the opening 210 may be formed at the lower end of the side portion 230. Alternatively, the closed portion 220 may be located at the lower end of the side portion 230 and the opening 210 may be located at the upper end of the side portion 230. As a result, the opening 210 and the closed portion 220 may be positioned to face each other with the receiving space therebetween.

The battery cell 10 may further include a cap plate 500. The cap plate 500 may close the opening 210. The housing 200 and the cap plate 500 may be coupled to close the receiving space. The cap plate 500 may have a shape corresponding to the opening 210. When the opening 210 has a circular shape, the cap plate 500 may also have a circular shape.

In an embodiment, the cap plate 500 may be coupled to the housing 200 after the electrode assembly 100 is received in the receiving space. By coupling the cap plate 500 to the housing 200, the housing 200 may be kept airtight.

The battery cell 10 may further include electrode current collector plates 310 and 320. The electrode current collector plates 310 and 320 may be electrically connected to the electrode assembly 100. The electrode current collector plates 310 and 320 may include a conductive material such as copper, gold, silver, aluminum, or the like. In an embodiment, the electrode current collector plates 310 and 320 may have a shape of a circle or a disk.

The electrode assembly 100 includes the first electrode 110 and the second electrode 120, which is described below. The electrode current collector plates 310 and 320 may include a first electrode current collector plate 310 and a second electrode current collector plate 320. The first electrode current collector plate 310 and the second electrode current collector plate 320 may be electrically connected to different electrodes of the electrode assembly 100, respectively. In an embodiment, the first electrode current collector plate 310 may be electrically connected to the first electrode 110. The second electrode current collector plate 320 may be electrically connected to the second electrode 120.

In an embodiment, the first electrode current collector plate 310 may be electrically connected to an electrode terminal 400. The second electrode current collector plate 320 may be electrically connected to the housing 200 or the cap plate 500. Aa a result, the electrode assembly 100 may be electrically connected to the outside.

The housing 200 may further include a through-hole 240. The electrode terminal 400 may be inserted into the through-hole 240. The electrode terminal 400 may include an electrically conductive material, and the interior and exterior of the housing 200 may be electrically connected through the electrode terminal 400.

In an embodiment, the through-hole 240 may be located in the closed portion 220. The through-hole 240 may be provided in the center of the closed portion 220. Referring to FIG. 1, the through-hole 240 may be located in the center of the closed portion 220, and the electrode terminal 400 may also be located in the center of the closed portion 220. The battery cell 10 may further include an insulating member 600. The insulating member 600 may be disposed between the housing 200 and the electrode terminal 400. For example, the insulating member 600 may be disposed between the closed portion 220 of the housing 200 and the electrode terminal 400. More specifically, the insulating member 600 may be formed into a structure surrounding the electrode terminal 400 to prevent contact between the electrode terminal 400 and the housing 200. The insulating member 600 may be a gasket.

The insulating member 600 may have insulating properties. The insulating properties may mean being electrically insulated. The insulating material may include a material with low electrical conductivity, such as a polymer, ceramic, or the like.

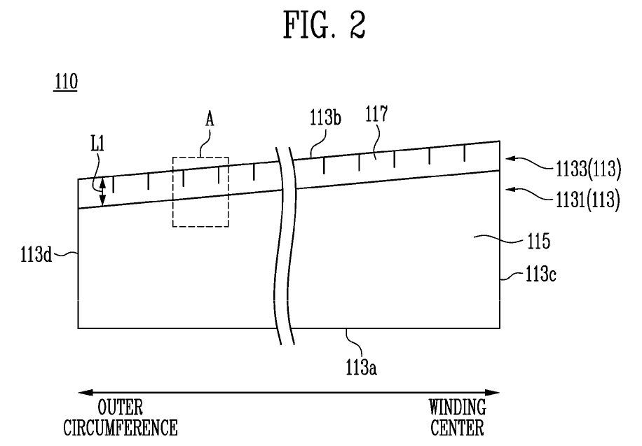

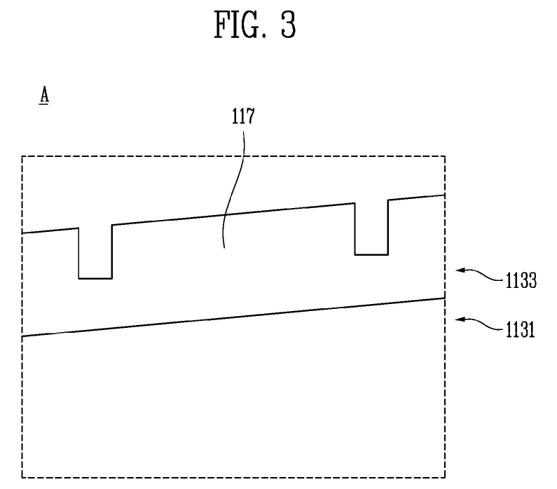

FIG. 2 illustrates the first electrode 110 according to an embodiment of the present disclosure, and FIG. 3 is an enlarged view of an area A of FIG. 2.

The electrode assembly 100 may include the first electrode 110 and the second electrode 120. The electrode assembly 100 may further include a separator 130. The second electrode 120 may be disposed on at least one surface of the first electrode 110. The separator 130 may be disposed between the first electrode 110 and the second electrode 120. In an embodiment, after the first electrode 110, the separator 130, and the second electrode 120 are disposed in a sequential manner, the first electrode 110, the separator 130, and the second electrode 120 may be wound into a roll.

The first electrode 110 and the second electrode 120 may be different electrodes. In an embodiment, the first electrode 110 may be an anode and the second electrode 120 may be a cathode. Alternatively, the first electrode 110 may be a cathode and the second electrode 120 may be an anode.

Specifically, FIG. 2 illustrates the first electrode 110 prior to being wound. The first electrode 110 may include the first current collector 113 and the first active material 115. The first current collector 113 may extend in one direction. The first active material 115 may coat at least one surface of the first current collector 113.

The first active material 115 may be a cathode active material or an anode active material. For example, the cathode and anode active materials may be materials which lithium ions are intercalated and from which the lithium ions are deintercalated, respectively. For example, the cathode active material may be a lithium metal oxide, and the anode active material may be one of crystalline carbon, amorphous carbon, carbon- based materials such as carbon composites, carbon fibers, lithium alloys, silicon (Si), and tin (Sn).

The first current collector 113 may be a cathode current collector or an anode current collector. The cathode or anode current collector may include any known conductive material, as long as the cathode or anode current collector does not cause a chemical reaction within the lithium secondary battery. For example, the cathode or anode current collector may include one of stainless steel, nickel (Ni), aluminum (Al), titanium (Ti), copper (Cu), and alloys thereof, and may be provided in various forms, such as film, sheet, foil, and the like.

When the first current collector 113 is a cathode current collector, the first active material 115 may be a cathode active material. When the first current collector 113 is an anode current collector, the first active material 115 may be an anode active material.

On the other hand, the second current collector 123 may be an anode current collector when the first current collector 113 is a cathode current collector such that the second electrode 120 may have a different polarity from the first electrode 110. Further, the second active material 125 may be an anode active material. Alternatively, the first electrode 110 and the second electrode 120 may be a cathode and an anode, respectively.

The first electrode 110 may include the first coated region 1131 where the first active material 115 is coated on the first current collector 113, and the first uncoated region 1133 formed adjacent to the first coated region 1131. The first uncoated region 1133 may refer to a region on the first current collector 113 which is not coated with the first active material 115.

The first active material 115 may coat the first current collector 113 in one direction. The first active material 115 may coat at least one surface of the first current collector 113. The first active material 115 may coat at least a portion of at least one surface of the first current collector 113.

In an embodiment, the first current collector 113 may be configured in the form of a sheet and may extend in one direction. When the first current collector 113 is in the form of a sheet, one edge may be longer than the other edge. The first current collector 113 may include long sides 113a and 113b and short sides 113c and 113d.

The first current collector 113 may be wound in a longitudinal direction. More specifically, after the first active material 115 is coated on the first electrode 110, the first current collector 113 may be wound in the longitudinal direction.

The first electrode 110 may have two opposing edges 113c and 113d in the longitudinal direction of the first electrode 110. The two opposing edges 113c and 113d in the longitudinal direction of the first electrode 110 may have different lengths. When the first electrode 110 is wound, one edge 113c of the two edges may face the winding center C and the other edge 113d may face the outer circumference.

Referring to FIG. 2, when the first electrode 110 is wound, one edge 113c of the first current collector 113 may face the winding center C, and the other edge 113d of the first current collector 113 may face the outer circumference. The one edge 113c of the first current collector 113 may be longer than the other edge 113d of the first current collector 113.

The first current collector 113 may be wound in a direction from the one edge 113c of the first current collector 113 toward the other edge 113d of the first current collector 113. In an embodiment, the first current collector 113 may have a trapezoidal shape.

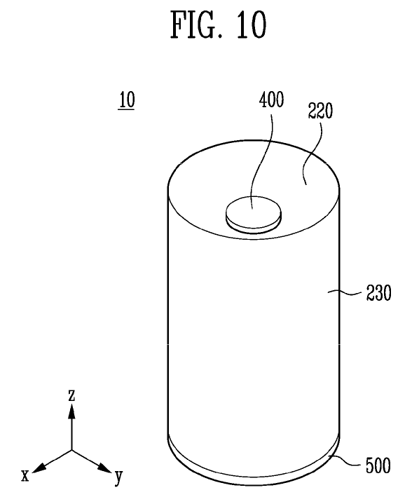

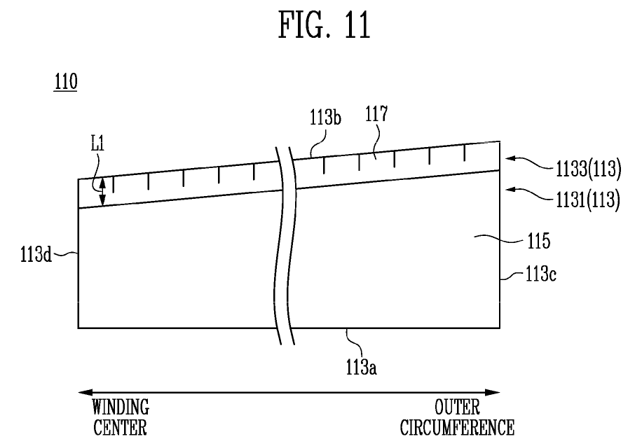

Thus, the electrode assembly 100 according to an embodiment of the present disclosure may have the winding center C which is longer than the outer circumference. The electrode assembly 100 according to another embodiment of the present disclosure may have the first current collector 113 wound in a direction from a shorter edge toward a longer edge, which is described below. The electrode assembly will be described in more detail below with reference to FIGS. 10 and 11.

The first active material 115 may be coated from one end of the first current collector 113 toward the winding center C to the other end of the first current collector 113. Referring to FIG. 2, the first active material 115 may be coated from one edge 113c of the first current collector 113 toward the other edge 113d of the first current collector 113. As a result, the first active material 115 may be evenly coated on the first current collector 113.

The first uncoated region 1133 may include one edge 113b of the first current collector 113 from one end of the first current collector 113 facing the winding center C toward the other end of the first current collector 113. In other words, the first uncoated region 1133 may be located on one side of the first current collector 113, and when the first electrode 110 is wound, the first uncoated region 1133 may be bent toward the winding center C.

In an embodiment, the first uncoated region 1133 may include the long side 113b of the first current collector 113. Referring to FIG. 2, the first uncoated region 1133 may include the long side 113b of the first current collector 113.

The first uncoated region 1133 may include a plurality of flags 117 formed at preset intervals. Referring to FIGS. 2 and 3, the plurality of flags 117 may be formed by cutting the first uncoated region 1133 at predetermined intervals. After the first electrode 110 is wound, the plurality of flags 117 may each be bent toward the winding center C.

On the other hand, the width of the first uncoated region 1133 may be constant. Referring to FIG. 2, a width L1 of the first uncoated region 1133 may be the same in the height direction of the first current collector 113. As described above, the first uncoated region 1133 may be bent toward the winding center C after being wound. In an embodiment, the bent first uncoated region 1133 may be welded to the first electrode current collector plate through a planarization process.

The first uncoated region 1133 may have a predetermined size to ensure welding quality. The electrode assembly 100 of the present disclosure may minimize the loss of the area to which the first active material 115 is applied and secure welding quality by maintaining a constant width of the first uncoated region 1133 even when the size of the first current collector 113 changes.

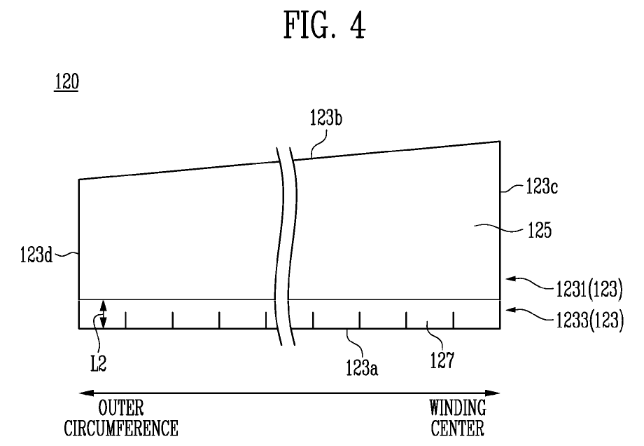

FIG. 4 illustrates the second electrode 120 according to an embodiment of the present disclosure.

Referring to FIG. 4, the second electrode 120 may include the second current collector 123 and the second active material 125. The second current collector 123 may extend in one direction. The second active material 125 may coat at least one surface of the second current collector 123.

The second electrode 120 may include the second coated region 1231 where the second active material 125 is coated on the second current collector 123, and the second uncoated region 1233 formed adjacent to the second coated region 1231. The second uncoated region 1233 may refer to a region on the second current collector 123 where the second active material 125 is not coated.

The second active material 125 may coat the second current collector 123 in one direction. The second active material 125 may coat at least one surface of the second current collector 123. The second active material 125 may coat at least a portion of at least one surface of the second current collector 123.

In an embodiment, the second current collector 123 may be formed in the form of a sheet and may extend in one direction. When the second current collector 123 is in the form of a sheet, one edge may be longer than the other edge. In other words, the second current collector 123 may include long sides 123a and 123b and short sides 123c and 123d.

The second current collector 123 may be wound in the longitudinal direction. More specifically, after the second active material 125 is coated on the second electrode 120, the second current collector 123 may be wound in the longitudinal direction.

The two edges 123c and 123d may face each other in the longitudinal direction of the second electrode 120. The two opposing edges 123c and 123d in the longitudinal direction of the second electrode 120 may have different lengths. When the second electrode 120 is wound, one of the two edges 123c may face the winding center C and the other edge 123d may face the outer circumference.

Referring to FIG. 4, when the second electrode 120 is wound, one edge 123c of the second current collector 123 may face the winding center C, and the other edge 123d of the second current collector 123 may face the outside. The one edge 123c of the second current collector 123 may be longer than the other edge 123d of the second current collector 123.

The second current collector 123 may be wound in a direction from one edge 123c of the second current collector 123 toward the other edge 123d of the second current collector 123. In an embodiment, the second current collector 123 may have a trapezoidal shape.

The second active material 125 may be coated from one end of the second current collector 123 toward the winding center C to the other end of the second current collector 123. Referring to FIG. 4, the second active material 125 may be coated from one edge 123c of the second current collector 123 toward the other edge 123d of the second current collector 123. As a result, the second active material 125 may be evenly coated on the second current collector 123.

The second uncoated region 1233 may include one edge 123b of the second current collector 123 from one end of the second current collector 123 facing the winding center C to the other edge of the second current collector 123.

In other words, the second uncoated region 1233 may be located on one side of the second current collector 123, and when the second electrode 120 is wound, the second uncoated region 1233 may be bent toward the winding center C.

In an embodiment, the second uncoated region 1233 may include a long side of the second current collector 123. Referring to FIG. 4, the second uncoated region 1233 may include the long side 123b of the second current collector 123.

In an embodiment, the second uncoated region 1233 may include a plurality of flags 127 arranged at predetermined intervals. For example, the second uncoated region 1233 may include a plurality of flags 127 formed at predetermined intervals. Referring to FIG. 4, the plurality of flags may be formed by cutting the second uncoated region 1233 at predetermined intervals. After the second electrode 120 is wound, the plurality of flags 127 may each be bent toward the winding center C.

The width of the second uncoated region 1233 may be constant. Referring to FIG. 4, a width L2 of the second uncoated region 1233 may be the same in the height direction of the second current collector 123.

In the same manner as described above with respect to the first electrode 110, the electrode assembly 100 according to another embodiment of the present disclosure may have the second current collector 123 which is wound in a direction from the shorter edge toward the longer edge. This will be described in more detail below with reference to FIGS. 10 and 11.

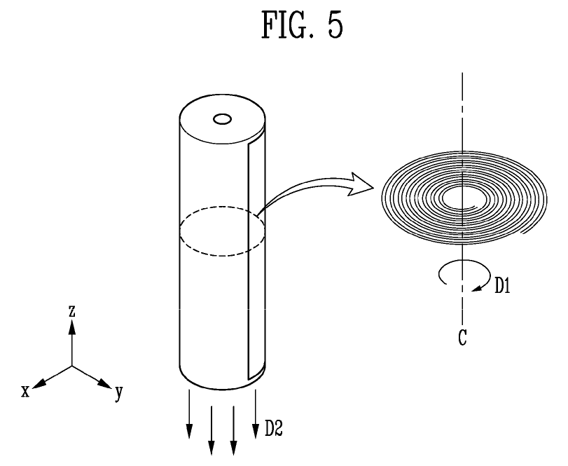

FIG. 5 schematically illustrates a path for heat to be dissipated from the electrode assembly 100 according to an embodiment of the present disclosure.

After the first electrode 110, the separator 130, and the second electrode 120 are wound into a roll, a large amount of heat may be generated during the charging and discharging processes. Referring to FIG. 5, in the wound state, the heat may be transferred in a winding direction D1 or in an axial direction D2 of the winding center C.

The heat transferred in the winding direction has a long heat transfer path, and the first electrode 110, the separator 130, and the second electrode 120 are in contact with each other, so that the heat may be efficiently transferred to the outside. However, the heat transferred in the axial direction of the winding center C may have a relatively short path compared to the path of the heat transferred in the winding direction. In addition, the heat transfer may not have to pass through other materials because each material (e.g., the first electrode or the second electrode) extends in the axial direction of the winding center C.

The electrode assembly 100 of the present disclosure may efficiently dissipate heat transmitted in the axial direction of the winding center C and improve cooling performance by increasing the surface area of a surface formed in the axial direction of the winding center C. To increase the surface area, the height of the electrode assembly 100 in a radial direction from the winding center C may be varied. More specifically, the height of at least one of the first current collector 113 and the second current collector 123 may be changed in the radial direction from the winding center C.

Furthermore, by forming the housing 200 to correspond to the shape of the electrode assembly 100, the energy density of the battery cell 10 may be maximized. In other words, since the housing 200 has the shape corresponding to the shape of the electrode assembly 100, wasted space inside the housing 200 may be prevented.

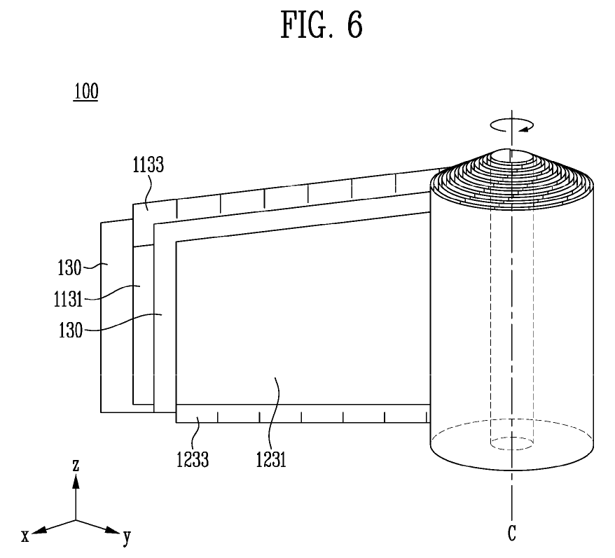

FIG. 6 illustrates the electrode assembly 100 according to an embodiment of the present disclosure. Specifically, FIG. 6 shows the electrode assembly 100 in which portions of the first electrode 110 and the second electrode 120 are wound.

Referring to FIG. 6, the electrode assembly 100 may include the winding center C. The winding center C may extend in the axial direction and may penetrate the top and bottom of the electrode assembly 100. The first electrode 110 and the second electrode 120 may be disposed in a crosswise manner in a radial direction about the winding center C. In an embodiment, the separator 130 may be further positioned between the first electrode 110 and the second electrode 120. Furthermore, the electrode assembly 100 may further include the separator 130 on the outermost side. As a result, the stability of the electrode assembly 100 may be improved.

The height of each of the first current collector 113 and the second current collector 123 may decrease in the radial direction from the winding center C. In other words, the height of the electrode assembly 100 may gradually decrease in the radial direction from the winding center C.

Referring to FIG. 2, the first current collector 113 may be wound in a direction from a longer edge 113c toward a shorter edge 113d between the short sides 113c and 113d of the first current collector 113, so that the longer edge 113c may be located at the winding center C and the shorter edge 113d may be located at the outer circumference.

As a result, the surface area of the surface which is formed in the axial direction of the winding center C may be increased when the first electrode 110 is wound.

The shape of the second current collector 123 may correspond to the shape of the first current collector 113. In an embodiment, when the first current collector 113 has a trapezoidal shape, the second current collector 123 may also have a trapezoidal shape. Accordingly, the energy density and stability of the electrode assembly 100 may be improved when the first electrode 110 and the second electrode 120 are wound.

Referring to FIG. 4, the second current collector 123 may be wound in a direction from a longer edge 123c to a shorter edge 123d between the short-side edges 123c and 123d of the second current collector 123, so that the longer edge 123c may be located at the winding center C and the shorter edge 123d to be located at the outer circumference.

In the axial direction of the winding center C, the second uncoated region 1233 may be formed on an opposite side of the first uncoated region 1133. Referring to FIG. 6, the first uncoated region 1133 may face upward (e.g., in the z-axis direction) and the second uncoated region 1233 may face downward.

Referring to FIG. 6, a process by which the electrode assembly 100 is wound according to an embodiment of the present disclosure will be described. In the embodiment, first, one edge of the first electrode 110 may be positioned relative to one edge of the second electrode 120. The separator 130 may be positioned between the first electrode 110 and the second electrode 120. As a result, the first electrode 110, the separator 130, and the second electrode 120 may be stacked in that order.

One edge of the first electrode 110 overlapping the second electrode 120 may be the longer edge 113c between the two opposing edges 113c and 113d in the winding direction. Further, one edge of the second electrode 120 overlapping the first electrode 110 may be the longer edge 123c between the two opposing edges 123c and 123d in the winding direction.

When the first electrode 110 and the second electrode 120 are positioned overlapping in this manner, the first uncoated region 1133 and the second uncoated region 1233 may be located in different directions. In the axial direction of the winding center C, the first uncoated region 1133 may face upward and the second uncoated region 1233 may face downward.

After the first electrode 110 and the second electrode 120 overlap each other, the first electrode 110 and the second electrode 120 may be wound together. The wound electrode assembly 100 may have a gradually decreasing height radially away from the winding center C.

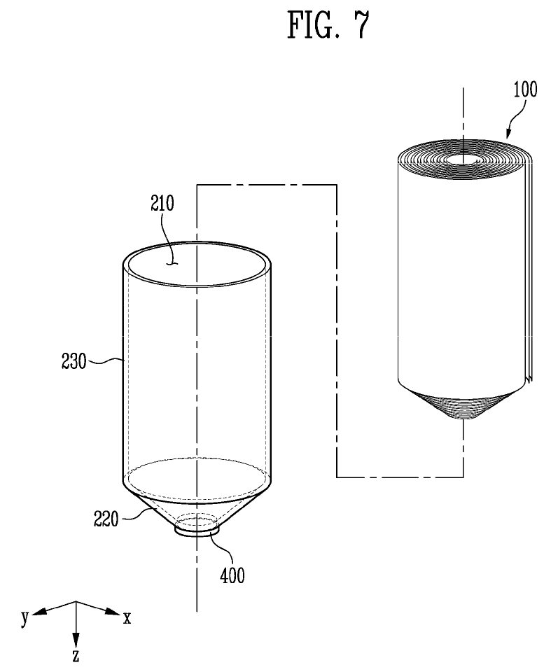

FIG. 7 illustrates how the electrode assembly 100 is inserted into the housing 200.

The electrode assembly 100 may be inserted into the housing 200 through the opening 210 in the housing 200. In an embodiment, the housing 200 may be positioned such that the opening 210 may face upward by making the housing 200 stand. The housing 200 may be in a state where the electrode terminal 400 is coupled to the closed portion 220. That is, the through-hole 240 of the housing 200 may be closed to the electrode terminal 400.

In an embodiment, the first electrode current collector plate 310 and the second electrode current collector plate 320 may be welded to the electrode assembly 100 in which the first electrode 110, the separator 130, and the second electrode 120 are wound. The first electrode current collector plate 310 may be welded to one surface of the electrode assembly 100. The second electrode current collector plate 320 may be welded to the other side of the electrode assembly 100.

In an embodiment, after the first electrode current collector plate 310 and the second electrode current collector plate 320 are welded to the electrode assembly 100, the electrode assembly 100 may be inserted into the housing 200. Once the electrode assembly 100 is inserted into the housing 200, the first electrode current collector plate 310 may be positioned between the closed portion 220 and the electrode assembly 100, and the second electrode current collector plate 320 may be positioned between the opening 210 and the electrode assembly 100.

The opposing surfaces of the electrode assembly 100 and the closed portion 220 may correspond to each other. Accordingly, after the electrode assembly 100 is inserted into the housing 200, the amount of empty space within the housing 200 may be reduced.

Referring to FIG. 7, the bottom (in the Z-axis direction) of the electrode assembly 100 and the closed portion 220 of the housing 200 may oppose each other. The electrode assembly 100 may protrude downwardly in the axial direction (e.g., the Z-axis direction) of the winding center C.

The closed portion 220 of the housing 200 may have a protruding region corresponding to the winding center C. The closed portion 220 of the housing 200 may also protrude downward in the axial direction (e.g., the z-axis direction) of the winding center C.

In an embodiment, after the electrode assembly 100 is inserted into the housing 200, an electrolyte may be injected into the housing 200. The electrolyte may be an electrolyte solution.

In an embodiment, the cap plate 500 may close the opening 210 after the electrolyte is injected. As a result, the electrode assembly 100 and electrolyte may be hermetically located in the housing 200.

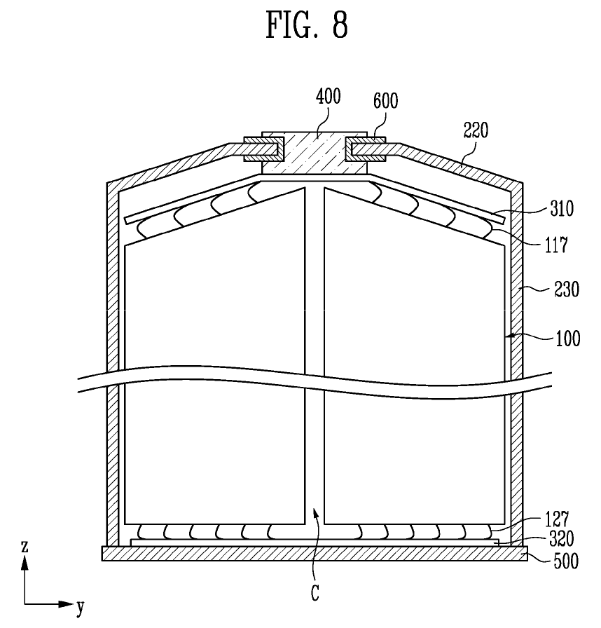

FIG. 8 is a cross-sectional view of the battery cell 10 according to an embodiment of the present disclosure.

The first electrode 110 of the electrode assembly 100 may be electrically connected to the first electrode current collector plate 310. The first electrode current collector plate 310 may be electrically connected to the electrode terminal 400. The second electrode 120 of the electrode assembly 100 may be electrically connected to the second electrode current collector plate 320. The second electrode current collector plate 320 may be electrically connected to the cap plate 500. As a result, the electrode assembly 100 may be electrically connected to the outside.

Also, referring to FIG. 8, the electrode assembly 100 may have a relatively protruding winding center C and a large surface area on one surface in the axial direction. Thus, heat may be quickly and efficiently dissipated through a heat transfer path in the axial direction of the winding center C.

In an embodiment, the closed portion 220 of the housing 200 may correspond to the electrode assembly 100. The closed portion 220 may correspond to one surface of the electrode assembly 100 which is recessed.

In an embodiment, the first electrode current collector plate 310 may also correspond to the electrode assembly 100. The first electrode current collector plate 310 may be inclined to cover the recessed one surface of the electrode assembly 100. When the first electrode current collector plate 310 is positioned on one surface of the electrode assembly 100, the first electrode current collector plate 310 may have a protruding portion at a position corresponding to the winding center C.

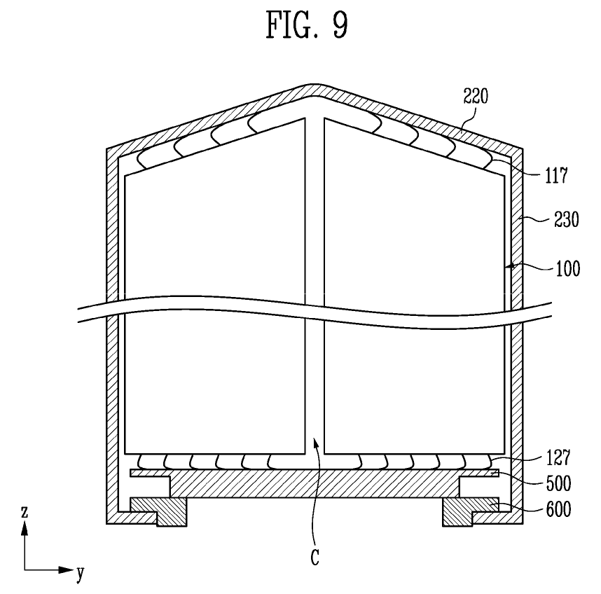

FIG. 9 is a cross-sectional view of the battery cell 10 according to another embodiment of the present disclosure.

The battery cell 10 according to another embodiment of the present disclosure may not be provided with the through-hole 240 in the closed portion 220. Referring to FIG. 9, the cap plate 500 may be coupled to the opening 210, and the insulating member 600 may be positioned between the opening 210 and the cap plate 500. As a result, the housing 200 and the cap plate 500 may be electrically isolated.

The first electrode 110 may be electrically connected to the closed portion 220 via the plurality of flags 117. The second electrode 120 may be electrically connected to the cap plate 500 via the plurality of flags 127. As a result, the housing 200 and the cap plate 500 may have different electrical polarities. The first current collector 113 and the second current collector 123 may be additionally provided, respectively.

FIG. 10 illustrates the battery cell 10 according to another embodiment of the present disclosure.

The battery cell 10 according to another embodiment of the present disclosure may have a recessed shape on one surface thereof. An upper surface or a lower surface of the battery cell 10 may be recessed, so that the heat transfer path in the axial direction of the winding center C of the electrode assembly 100 may be reduced.

In one embodiment, the closed portion 220 has a recessed region corresponding to the winding center C. For example, referring to FIG. 10, a region corresponding to the winding center C of the closed portion 220 may be recessed. The battery cell 10 may be configured such that the closed portion 220 may be recessed in the axial direction of the winding center C towards the receiving space. The battery cell 10 according to another embodiment of the present disclosure may include the electrode assembly 100 with the recessed one surface.

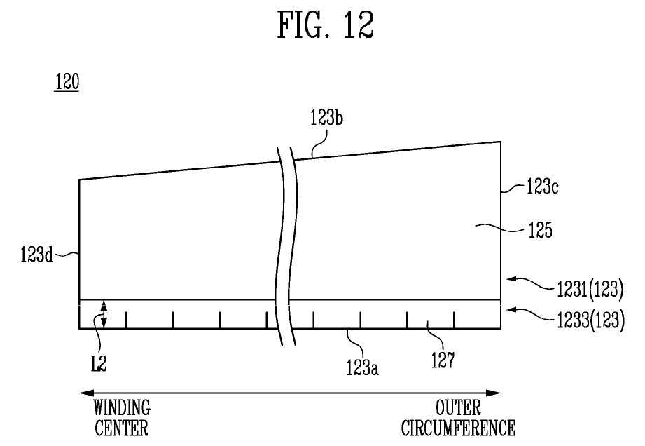

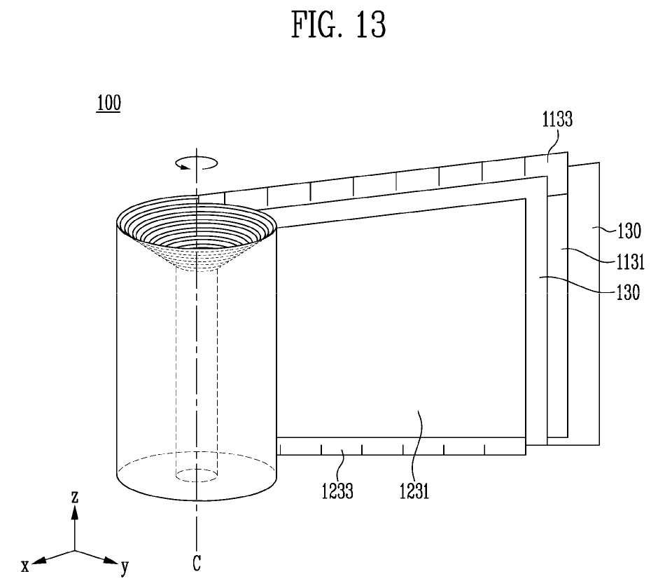

FIG. 11 illustrates the first electrode 110 according to another embodiment of the present disclosure, FIG. 12 illustrates the second electrode 120 according to another embodiment of the present disclosure, and FIG. 13 illustrates the electrode assembly 100 according to another embodiment of the present disclosure.

The first electrode 110 and the second electrode 120 according to another embodiment of the present disclosure may be configured in the same forms as the first electrode 110 and the second electrode 120 as described above. However, the winding direction of the first electrode 110 and the second electrode 120 may be different in order to manufacture the electrode assembly 100 according to another embodiment of the present disclosure.

Since the same descriptions as above are applicable except for the winding direction, only the winding direction will be described below.

Referring to FIG. 11, when the first electrode 110 is wound, the other edge 113d of the first current collector 113 may face the winding center C, and one edge 113c of the first current collector 113 may face the outer circumference. The one edge 113c of the first current collector 113 may be longer than the other edge 113d of the first current collector 113.

The first current collector 113 may be wound in a direction toward the one edge 113c of the first current collector 113 from the other edge 113d of the first current collector 113. As a result, the winding center C may be shorter than the outer circumference when the first electrode 110 is wound.

Also, referring to FIG. 12, when the second electrode 120 is wound, one edge 123c of the second current collector 123 may face the winding center C, and the other edge 123d of the second current collector 123 may face the outer circumference. The one edge 123c of the second current collector 123 may be longer than the other edge 123d of the second current collector 123.

The second current collector 123 may be wound in a direction toward the one edge 123c of the second current collector 123 from the other edge 123d of the second current collector 123. Accordingly, the winding center C may be formed shorter than the outer circumference when the second electrode 120 is wound.

Referring to FIG. 13, the heights of the first current collector 113 and the second current collector 123 may be increased in the radial direction from the winding center C.

Referring to FIG. 13, a process by which the electrode assembly 100 is wound according to another embodiment of the present disclosure will be described. In this embodiment, first, the one edge 113d of the first electrode 110 may be positioned relative to the other edge 123d of the second electrode 120. The separator 130 may be positioned between the first electrode 110 and the second electrode 120. Accordingly, the first electrode 110, the separator 130, and the second electrode 120 may be stacked in that order.

The other edge of the first electrode 110 overlapping the second electrode 120 may be a shorter edge 113d between the two opposing edges 113c and 113d in the winding direction. Further, the other edge of the second electrode 120 overlapping the first electrode 110 may be a shorter edge 123d between the two opposing edges 123c and 123d in the winding direction.

When the first electrode 110 and the second electrode 120 are thus positioned on top of each other, the first uncoated region 1133 and the second uncoated region 1233 may be located in different directions. Along the axial direction of the winding center C, the first uncoated region 1133 may face upward and the second uncoated region 1233 may face downward.

After the first electrode 110 and the second electrode 120 overlap each other, the first electrode 110 and the second electrode 120 may be wound together. The wound electrode assembly 100 may gradually increase in height radially away from the winding center C.

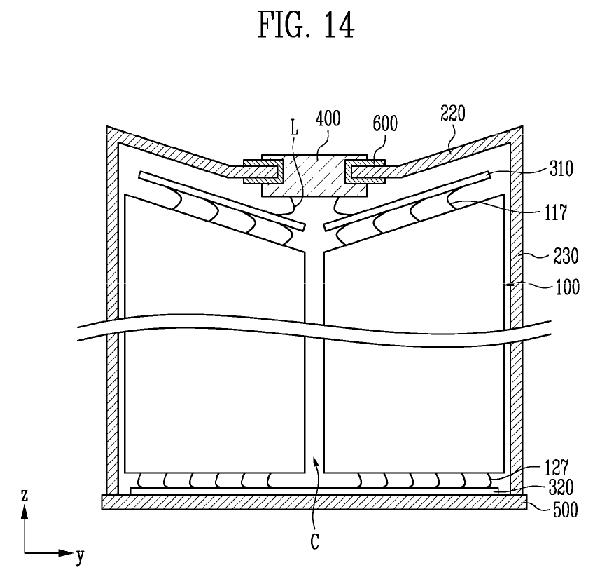

FIG. 14 is a cross-sectional view of the battery cell 10 according to another embodiment of the present disclosure.

Referring to FIG. 14, the closed portion 220 of the housing 200 may correspond to the electrode assembly 100. The closed portion 220 may correspond to the recessed one surface of the electrode assembly 100.

In an embodiment, when the first electrode current collector plate 310 is positioned on one surface of the electrode assembly 100, the first electrode current collector plate 310 may have a protruding portion at a position corresponding to the winding center C.

In an embodiment, the battery cell 10 of the present disclosure may further include a lead 330 connecting the first electrode current collector plate 310 and the electrode terminal 400. The lead 330 may include an electrically conductive material. Accordingly, the lead 330 may electrically connect the first electrode current collector plate 310 and the electrode terminal 400.

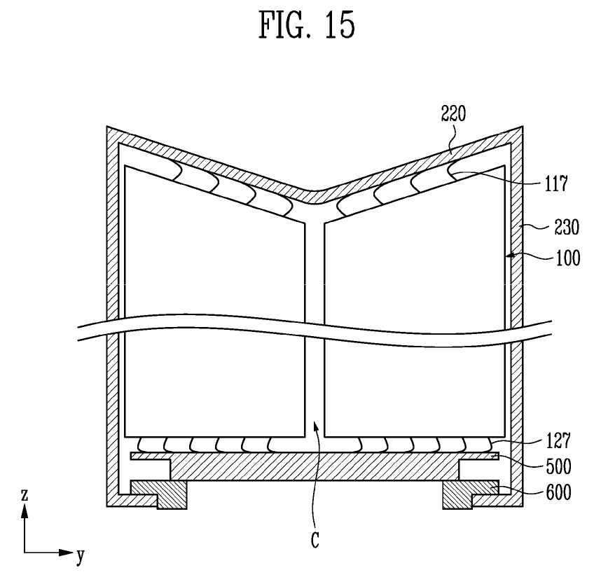

FIG. 15 is a cross-sectional view of the battery cell 10 according to another embodiment of the present disclosure.

Referring to FIG. 15, the battery cell 10 according to another embodiment of the present disclosure may not be provided with the through-hole 240 in the closed portion 220. Referring to FIG. 15, the cap plate 500 may be coupled to the opening 210, but the insulating member 600 may be positioned between the opening 210 and the cap plate 500. As a result, the housing 200 and the cap plate 500 may be electrically isolated.

The first electrode 110 may be electrically connected to the closed portion 220 via the plurality of flags 117. The second electrode 120 may be electrically connected to the cap plate 500 via the plurality of flags 127. Thus, the housing 200 and the cap plate 500 may have different electrical polarities. The first current collector 113 and the second current collector 123 may be additionally provided, respectively.

According to an embodiment of the present disclosure, an electrode assembly and a battery cell with improved stability and performance may be provided.

In addition, according to another embodiment of the present disclosure, an electrode assembly and a battery cell with improved cooling efficiency may be provided.

The present disclosure may be modified and implemented in various forms, and its scope is not limited to the above-described embodiments. The content described above is merely an example of applying the principles of the present disclosure, and other features may be further included without departing from the scope of embodiments according to the present disclosure.

What is claimed is:

1. An electrode assembly, comprising:
a first electrode and a second electrode;
wherein the first electrode and the second electrode are wound into a roll,
wherein the first electrode comprises a first coated region in which a first active material is coated on a first current collector, and a first uncoated region adjacent to the first coated region,
wherein the second electrode comprises a second coated region in which a
second active material is coated on a second current collector, and a second uncoated region adjacent to the second coated region, and wherein a height of at least one of the first current collector and the second current collector varies in a radial direction from a winding center.

2. The electrode assembly according to claim 1, wherein the height of each of the first current collector and the second current collector decreases in the radial direction from the winding center.

3. The electrode assembly according to claim 1, wherein the height of each of the first current collector and the second current collector increases in the radial direction from the winding center.

4. The electrode assembly according to claim 1, wherein the first active material is coated from one end of the first current collector toward the winding center to an other end of the first current collector.

5. The electrode assembly according to claim 4, wherein the first uncoated region comprises one edge of the first current collector from the one end of the first current collector toward the winding center to the other end of the first current collector.

6. The electrode assembly according to claim 5, wherein a width of the first uncoated region is the same in a height direction of the first current collector.

7. The electrode assembly according to claim 1, wherein the first uncoated region comprises a plurality of flags arranged at predetermined intervals.

8. The electrode assembly according to claim 1, wherein the first current collector has a trapezoidal shape.

9. The electrode assembly according to claim 1, wherein the second electrode is disposed on at least one surface of the first electrode.

10. The electrode assembly according to claim 1, wherein a shape of the second current collector corresponds to a shape of the first current collector.

11. The electrode assembly according to claim 9, wherein the second uncoated region is provided on an opposite side of the first uncoated region in the axial direction of the winding center.

12. The electrode assembly according to claim 1, wherein the second uncoated region comprises a plurality of flags arranged at predetermined intervals.

13. The electrode assembly according to claim 9, wherein the second current collector has a trapezoidal shape.

14. A battery cell, comprising: the electrode assembly according to claim 1; and
a housing receiving the electrode assembly.

15. The battery cell according to claim 14, wherein the housing comprises: an opening opened at one end; and a closed portion provided on an opposite side of the opening, and
wherein opposing surfaces of the electrode assembly and the closed portion correspond to each other.

16. The battery cell according to claim 15, wherein the closed portion has a protruding region corresponding to the winding center.

17. The battery cell according to claim 15, wherein the closed portion has a recessed region corresponding to the winding center.
